(19) United States
(12) Patent Application Publication
(10) Pub. No.: US 2007/0097835 A1
(43) Pub. Date: May 3, 2007

(54) Optical pick-up having a rotary arm actuator

(75) Inventors: Willem Gerard Ophey, Eindhoven (NL); Gerard Eduard Van Rosmalen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,650

(22) PCT Filed: Dec. 13, 2004
(86) PCT No.: PCT/IB04/04154

§ 371 Date: Jun. 20, 2006

(30) Foreign Application Priority Data
Dec. 23, 2003 (EP) 03300288.2

(51) Int. Cl. G11B 7/135

(52) U.S. Cl. 369/112.21

(57) ABSTRACT

A pivoting optical readout device is described in which two folding mirrors (121, 122) are used in an optical path (21) between an optical information carrier and a photodetector unit (112), for rotating a beam of light reflected from the information carrier by 90° such that a push-pull error-tracking signal can be generated.

### TECHNICAL FIELD OF THE INVENTION

The present invention relates to an optical pick-up having a first stationary part and a second pivoting part, wherein the second part is provided with an optical system for defining a beam path for a laser beam from a laser source towards an optically readable information carrier. The invention also relates to an optical drive comprising such a pick-up device.

### BACKGROUND OF THE INVENTION

Optical pick-ups can be designed in the form of a pivoting optical device, in which a laser diode is mounted in a stationary structure separate from the actual swing arm of the pivoting device. The provision of the laser diode in the swing arm itself would present some major disadvantages, such as increased arm mass, complicated handling of the heat generated by the laser diode, complex wiring, etc. Therefore, it is often preferred to have the laser diode mounted in a stationary structure separate from the swing arm.

In an optical pick-up as described above, different parts of the asymmetric emission from the laser diode are focused on the information carrier for different positions of the swing arm. This can be accomplished by having the fast axis of the laser diode (i.e. the most divergent dimension) parallel to the plane in which the swing arm pivots during scanning of the information carrier, i.e. the plane of the information carrier. A small motion in the orthogonal direction is also allowed for, by virtue of the divergence of the emission from the laser diode in this direction. Light emitted by the laser diode travels along the optical system in the pivoting part of the pick-up, and is directed towards the information carrier by means of a folding mirror.

For this kind of optical pick-up, focus error detection can be accomplished by the what is called Foucault method using a double wedge or roof prism. This method is well known to those skilled in the art.

However, no push-pull tracking-error signal can be produced in such case even if a double-roof prism is incorporated and the detecting photo diodes are divided both laterally and vertically. This kind of division can only be used for generating a signal for the rotation angle of the swing arm, which can be employed for controlling the driving of the arm.

Thus, there is a problem in the prior art concerning how to generate a push-pull tracking-error signal for rotary arm actuators of the above-mentioned kind.

### SUMMARY OF THE INVENTION

An object of the present invention is therefore to provide a solution by which one-beam push-pull tracking can be performed in an optical pick-up using a rotary arm actuator.

This object is met by an arrangement and an optical drive as set forth in the claims that follow.

Hence, according to the present invention, an optical pick-up is provided in which there is an optical system for defining a beam path from a laser source to an optical focusing unit for optical read-out of an information carrier. The optical system is mounted in a part of the device that is pivoting about a first pivot axis. A first folding mirror is provided for folding the beam path by 90° in a plane which is parallel to said pivot axis, and a second folding mirror is provided for folding the beam path by 90° in a plane that is orthogonal to said pivot axis. In this way, the light beam reflected from the information carrier is rotated such that is it imaged onto a detection unit rotated by 90°. Thereby, any push-pull asymmetry in the reflected beam can be detected in order to generate a push-pull tracking-error signal. Splitting the reflected beam by means of a roof-prism will give different power in the two portions of the beam, thus allowing the generation of this tracking-error signal.

In one embodiment of the invention, a double roof-prism is used for dividing the reflected beam into four sub-beams, together with a detection unit divided both laterally and vertically. In addition to the push-pull tracking-error signal, the device is then capable of generating a rotation angle position signal which can be used for controlling the pivot position of the swing arm.

Hence, the basic idea of the present invention is the use of an extra folding mirror in the optical beam path in order to rotate the reflected beam by 90°, such that any push-pull asymmetry in the beam can be detected.

### BRIEF DESCRIPTION OF THE DRAWINGS

The detailed description that follows will be better understood when read in conjunction with the accompanying drawings, in which:

FIG. 1 is a schematic perspective view of an arrangement for an optical pick-up according to the present invention;

FIG. 2 is a schematic side view in cross-section, illustrating a detail of FIG. 1;

FIG. 3 is a diagram showing the dimensional relation between a collimating lens of the optical pick-up and a far field radiation pattern from a laser diode;

FIG. 4 schematically shows a perspective view of a polarizing beam splitter with a roof-prism and the arrangement of an extra folding mirror according to the present invention; and

FIG. 5 schematically shows a perspective view of a polarizing beam splitter with double roof-prism, according to the present invention.

On the drawings, like parts are designated by like reference numerals throughout.

### DETAILED DESCRIPTION OF THE PREFERRED EMBODIMENT

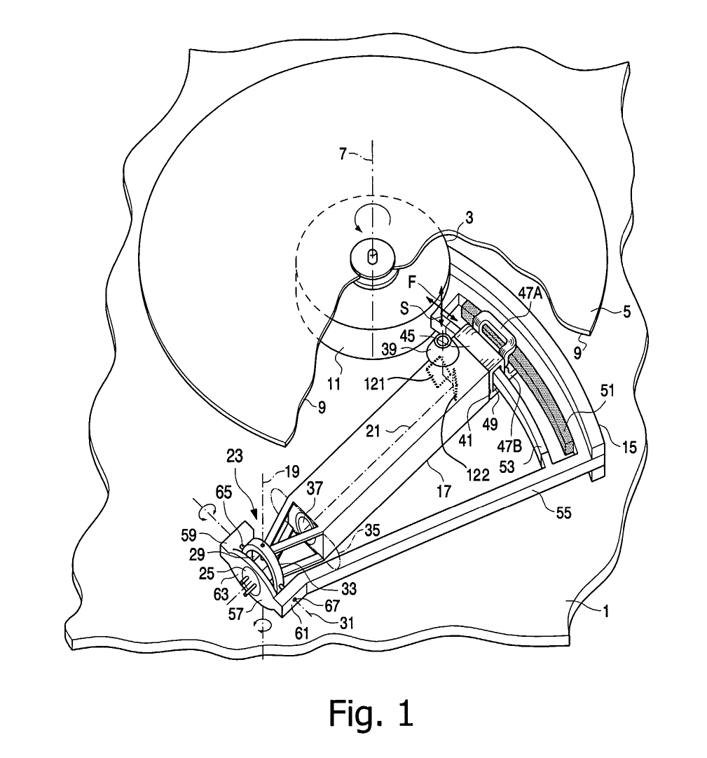

By way of introduction, a pivoting optical device of a general kind will be described with reference to FIG. 1.

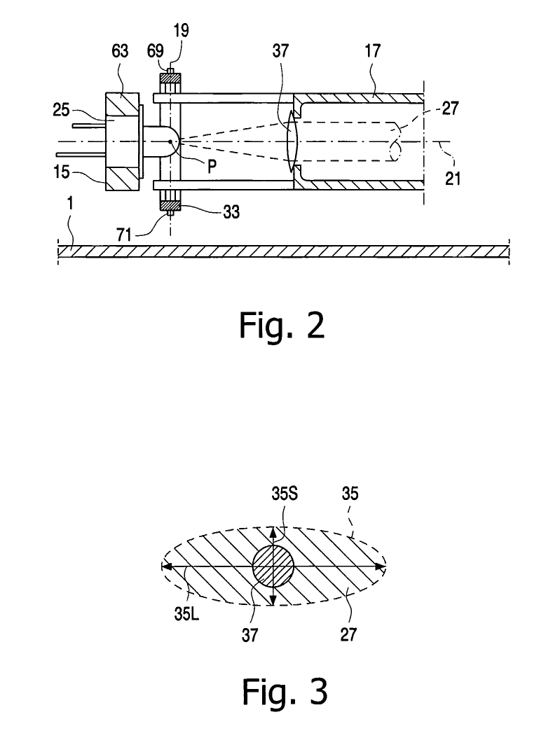

In FIG. 1, a pivoting optical device is shown in the form of an optical disc drive of general design. The optical disc drive of FIG. 1 comprises a base plate 1 supporting a spindle motor 3 for rotating an optical disc 5 about a spindle axis 7. The optical disc 5 has an information-carrying surface at its lower side. A peripheral outer surface 11 of the spindle motor 3 has a pivoting optical device attached to it, spaced from the base plate 1. It comprises a first part 15 and a second part 17. The second part 17 comprises an optical system which is pivotally movable relative to the first part 15 about a first pivot axis 19, said optical system defining an optical laser beam path 21 the general direction of which is indicated by a dash-dot line and generally extends in the longitudinal direction of the second part 17. Bearing means 23 are provided in order to provide the pivotability to the second part 17. A laser source 25 is attached to the first part 15 for emitting a laser beam 27 in the general longitudinal direction of the second part 17 along the beam path 21 (see FIG. 2).

The laser source 25 is located substantially on the optical laser beam path of the second part 17. To this end, the bearing means 23 presents an open center region 29 in order to allow the laser beam 27 to pass from the laser source 25 into the second pivoting part 17.

The second part 17 is also pivoting relative to the first part 15 about a second pivot axis 31, substantially orthogonally intersecting the first pivot axis 19 at a point of intersection P. The laser source 25 is located substantially at this point of intersection P.

Suitably, the bearing means is of the gimbal type, comprising an intermediate bearing element 33 which is pivotally supported by the first part 15 and which in turn pivotally supports the second part 17. The point of intersection P is located at the center point of the intermediate bearing element 33.

The laser source 25 is a semiconductor laser diode unit of a type known per se. The laser source 25 emits radiation having a far field radiation pattern 35 which is generally elliptical, as indicated in FIG. 3 which shows a transverse cross-section of the beam 27. The elliptical far field pattern has a major axis 35L and a minor axis 35S. The laser source 25 is arranged in such a manner that the major axis 35L is generally parallel to the second pivot axis 31, and the minor axis 35S is generally parallel to the first pivot axis 19.

The optical system of the second part 17 comprises an optical collimator in the form of a collimating lens 37 at the point of entry of the laser beam 27 into the second part 17. The collimating lens 37 is positioned entirely within the elliptical far field pattern 35 of the radiation emitted by the laser source 25 at all pivotal positions of the second part 17. This arrangement of the collimating lens is schematically shown in FIG. 3.

The pivoting optical device described so far is a swing arm for supporting an optical focusing unit 39 close to its free end 41 for reading/writing information from/to the information surface 9 of the optical disc 5. The second part 17 is a rigid swing arm for pivoting, scanning motion about a swing axis constituted by the first pivot axis 19, and for pivoting, focusing motion about a focusing axis constituted by the second pivot axis 31. As mentioned above, the focusing axis intersects the swing axis substantially orthogonally at the point of intersection P for moving the optical pick-up unit 39 in substantially orthogonal focusing and scanning directions F and S, respectively, relative to the information surface 9 on the optical disc 5. Hence, the major axis 35L of the far field radiation pattern 35 is generally parallel to the focusing axis 31, and the minor axis 35S thereof is generally parallel to the swing axis 19.

The embodiment of a swing arm device shown in FIG. 1 is of a type in which the second part is a rigid swing arm structure 17 that pivotally moves as a whole about the swing axis 19 and the focusing axis 31. To enable these pivotal movements, magnetic scanning and focusing means are provided, comprising the first part 15 which is of magnetically permeable material and acts as a stator structure and a number of movable magnetic coils 45, 47A, 47B, which are provided at the free end 41 of the swing arm structure 17 for scanning and focusing, respectively. The movable magnetic scanning coil comprises a cylindrical scanning coil 45 having a generally rectangular shape in cross-section and having a central opening 49. The movable focusing coils are two substantially identical cylindrical focusing coils 47A, 47B, having a generally rectangular shape in cross-section. The scanning coil 45 has been bonded at an outer side surface against the free end 41 of the swing arm structure 17 in a position in which the central axis thereof is generally parallel to the scanning movements S of the swing arm structure. Each focusing coil 47A, 47B has been bonded at a portion of their outwardly facing axial end surface against an outer side surface of the scanning coil 45, which is remote from the swing arm structure 17, and the two focusing coils 47A, 47B are disposed in the manner generally shown in FIG. 1. The first part 15 supports stationary magnetic means comprising an elongate permanent magnet 51 facing the focusing coils 47A, 47B and spaced from them by an air gap. The magnetically permeable stator or first part 15 has a stator part 53 passing through the central opening 49 of the scanning coil 45 with clearance. The permanent magnet is magnetically polarized in a radial direction relative to the swing axis 19, and the arrangement is such that a substantially radially directed permanent magnetic field is established across the air gaps which are present between the scanning coil 49 and the stator part 53 and between the focusing coils 47A, 47B and the stator 15, respectively. The stator 15 is rigidly associated with the spindle motor 3.

The stator core 15 and supporting portions of the gimbal-type bearing means 23 are suitably integrated into a combined unit. Such a combined unit is made of a suitable magnetically permeable material such as soft iron, and comprises a temporarily removable part, namely the part 53, to enable insertion of the scanning coil 45 into the central opening 49. This combined unit is provided with an interconnecting supporting beam part 55 carrying the bearing means 23 near its free end and may be comprised of a stack of stator laminations which may be integrated with the motor stator of the spindle motor 3.

As can be seen from FIG. 1, the first part 15 is generally U-shaped in plan view at its free end 57, comprising two legs 59, 61 and a connecting part 63. Pivoting pins 65, 67 pivotally support the intermediate part 33 in the legs 59, 61. In turn, the second part 17 is pivotally carried by the intermediate bearing part 31 by two pivoting pins 69, 71. The laser diode is inserted in a matching opening in the connecting part 63 of the U-shaped end of the first part 15 in such a way that the active diode surface is situated at the point of intersection P of the swing axis 19 and the focusing axis 31 of the second part 17.

FIG. 3 shows a projection of the collimating lens 37 in the form of a circular shaded area, projected onto the local far field radiation pattern shown as a differently shaded area. The projection of FIG. 3 shows an orthogonal plane through the plane of the collimating lens 37. The collimating lens remains within the boundaries of the far field radiation pattern 35 in all operational positions of the swing arm 17. The focusing amplitudes of the swing arm for optical disc drives are much smaller than the swing amplitudes in the orthogonal plane. The elliptical far field pattern of the radiation from a laser diode is therefore well suited for a pivoting optical device in optical disc drives.

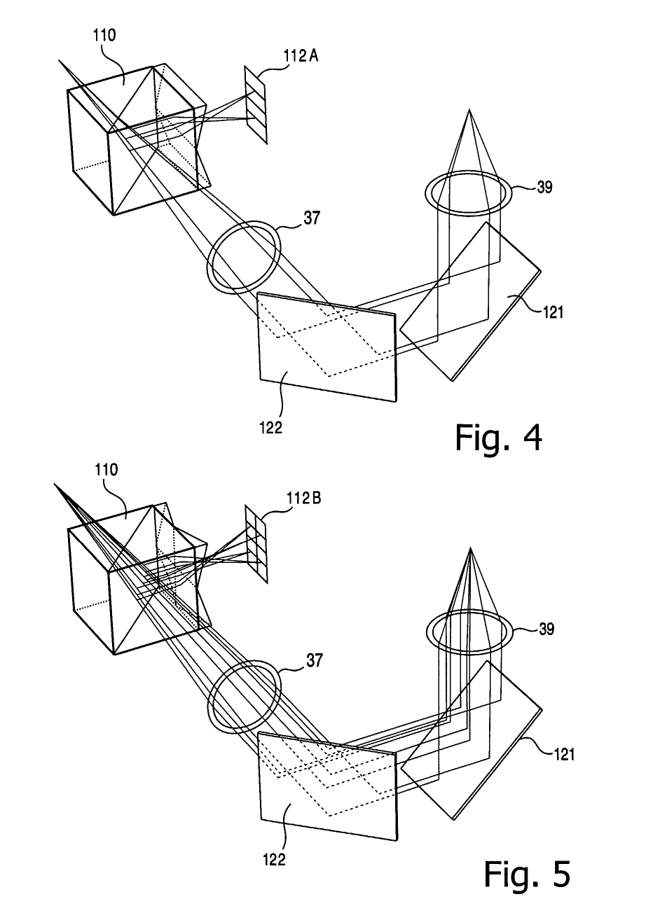

Typically, a polarizing beam splitter 110 or some other light-deflecting means will be provided between the laser diode 25 and the collimating lens 37, in order to direct light reflected from the information carrier towards an array of photodiodes or photodetector or the like referenced by 112 in FIG. 4 for read-out. To accommodate for the displacement of the image on the photodiodes when the swing arm pivots about its pivot axis, the photodiodes 112A are divided into sections parallel to the swing plane of the swing arm. It is to be noted that rotation of the swing arm leads to a displacement of the image on the photodiodes in the same plane as the swing arm rotation. The image on the photodiodes does not move in the orthogonal direction.

In order to have the possibility of generating a push-pull tracking-error signal that is independent of the rotation of the swing arm, an extra folding mirror 122 is provided. Hence, one folding mirror 121 has the purpose of directing the laser beam 27 onto the information carrier, and the extra folding mirror 122 has the purpose of rotating the beam such that it is imaged onto the photo-detectors rotated by 90° compared to a situation where there is no extra folding mirror. In other words, the first folding mirror 121 is provided for folding the optical beam path by 90° in a plane which is parallel to the swing axis 19 of the device, and the second folding mirror 122 is provided for folding the beam path by 90° in a plane which is orthogonal to this swing axis 19. In this way, the photo-detectors can be used for generating the push-pull signal required for proper tracking of the information carrier. A difference in light intensity between two opposite edges of the laser beam after reflection from the information carrier (due to a tracking error) can now be resolved through a difference in signal strength from two adjacent photo-detectors. The arrangement of two folding mirrors 121, 122 is indicated in FIG. 1, but is better seen from FIGS. 4 and 5.

It should be pointed out that, when using a polarizing beam splitter (PBS), a quarter-wave plate (λ/4-plate) is typically positioned between said PBS and the information carrier. In this case, the λ/4-plate should be positioned between the second folding mirror and the objective lens.

Preferably, the collimating lens employed in the optical system has an aspherical surface in order to provide adequate collimation of the emission from the laser diode.

When a polarizing beam splitter (PBS) 110 is arranged between the laser diode 25 and the collimating lens 37, the collimating lens will only be perpendicular to the beam splitter at one position. For any other orientation or rotation of the second, pivoting part, the collimating lens 37 will have an angle with respect to the PBS 110. This will give rise to aberrations, mainly astigmatism. However, it is quite straightforward to compensate for this, for example by selecting appropriate numerical apertures for the collimating lens and/or by providing an aspherical surface in front of the PBS.

In a further embodiment of the present invention, shown in FIG. 5, the set-up is provided with a double roof-prism between the PBS and the photodiodes referred to by 112B, together with a division of the photodiodes 112B both laterally and vertically. In addition to the push-pull tracking-error signal, the inventive device is then capable of also providing a rotation angle position signal, which can be used for controlling the swing arm position.

Although a bearing means 23 having a generally circular shape has been described, it is to be understood that other shapes and types may be employed for the bearing means. For example, the gimbal-type bearing may be of rectangular shape. Other examples of bearing means include spherical bearings. It will be understood that the present invention can be employed regardless of the type of bearing, provided that the pivoting functions described above are implemented.

In conclusion, an optical read-out device has been disclosed, comprising a first (stationary) part and a second (pivoting) part. The second part carries an optical system and is pivotally movable relative to the first part about a first pivot axis, wherein the optical system defines a beam path for a laser beam in a generally longitudinal direction of the second part. Further, a laser source is located substantially at the point where the first pivot axis and the beam path intersect. In order to direct the laser beam from the diode laser onto an optically readable information carrier and at the same time allow the generation of a push-pull tracking-error signal, a first folding mirror is provided for folding the beam path by 90° in a first plane which is parallel to the first pivot axis, and a second folding mirror is provided for folding the beam path by 90° in a second plane which is orthogonal to the first pivot axis.

Moreover, a double roof-prism can be employed together with a photodetector array in order to simultaneously generate both the tracking-error signal and a rotation angle position signal for the swing arm.

Hence, a pivoting optical readout device has been described in which two folding mirrors 121, 122 are used in an optical path 21 between an optical information carrier 9 and a photodetector unit 112A (or 112B), for rotating a beam of light reflected from the information carrier by 90° such that a push-pull error-tracking signal can be generated.

1. An optical pick-up device, comprising:
a first part (15);
a second part (17) carrying an optical system and being pivotally movable relative to said first part about a first pivot axis (19), said optical system defining a beam path (21) for a laser beam in a generally longitudinal direction along said second part;
a laser source (25) located substantially at the point (P) where said first pivot axis (19) and said beam path (21) intersect; wherein said optical system comprises
a first folding mirror (121) for folding said beam path by 90° in a first plane which is essentially parallel to said first pivot axis (19), and
a second folding mirror (122) for folding said beam path by 90° in a second plane which is essentially orthogonal to said first pivot axis (19).

2. A device as claimed in claim 1, further comprising a polarizing beam splitter (110) adjacent to the laser source (25) for directing light reflected from an information carrier (9) towards an arrangement of photodiodes (112) for read-out.

3. A device as claimed in claim 2, further comprising a roof-prism for splitting said reflected light into two separate beams towards the photodiodes.

4. A device as claimed in claim 2, further comprising a double roof-prism for splitting said reflected light into four separate beams towards the photodiodes.

5. A device as claimed in claim 1, wherein the second part is also pivotally movable relative to said first part about a second pivot axis (31), this second pivot axis intersecting said first pivot axis substantially orthogonally at the point (P) where said first pivot axis (19) and said beam path (21) intersect.

6. A device as claimed in claim 1, further comprising a collimating lens (37) for collimating the emission from the laser source (25) upon entry into the second part (17).

7. A device as claimed in claim 6, wherein the collimating lens (37) and the laser source (25) are positioned such that said lens (37) is within the far field radiation pattern of the laser source (25) at all operational positions of the second part (17).

8. A device as claimed in claim 5, wherein the first pivot axis (19) is generally parallel to a minor axis of the far field radiation pattern of the laser source (25), and the second pivot axis (31) is generally parallel to a major axis of the far field radiation pattern of said laser source.

9. An optical drive, comprising a pick-up device as claimed in claim 1.
